(19) United States
(12) Patent Application Publication
(10) Pub. No.: US 2022/0294372 A1
(43) Pub. Date: Sep. 15, 2022

(54) GENERATOR

(71) Applicant: HONDA MOTOR CO., LTD., Tokyo (JP)

(72) Inventors: Daisuke Teruya, Wako-shi (JP); Sho Takada, Wako-shi (JP)

(21) Appl. No.: 17/668,961

(22) Filed: Feb. 10, 2022

(30) Foreign Application Priority Data
Mar. 11, 2021 (JP) 2021-039192

(51) Int. Cl. H02P 9/08

(52) U.S. Cl. CPC H02P 9/08; H02P 2101/25

(57) ABSTRACT

A generator includes: an engine; an alternator attached to an output shaft of the engine; an inverter that rectifies current flowing between the alternator and a power receptacle (power input-output part) in both directions and performs power conversion; an ECU that supplied electric power to the inverter and controls the engine and the inverter; and a starting unit that supplies, to the ECU, electric power from an external power supply device to be connected to the power receptacle, and the alternator is energized to start the engine, by sending a starting initiation instruction from the ECU to the inverter.

### INCORPORATION BY REFERENCE

The present application claims priority under 35 U.S.C. § 119 to Japanese Patent Application No. 2021-039192 filed on Mar. 11, 2021. The content of the application is incorporated herein by reference in its entirety.

### BACKGROUND OF THE INVENTION

### Field of the Invention

The present invention relates to a generator.

### Description of the Related Art

For a generator, there has been conventionally disclosed a technology of two sets or more of electric generators connected in series, each set including a motor and a generator which is rotated by the motor's rotation (for example, see WO2007/026752). In this technology, the motor of the electric generator of the first set is a starting motor, the starting motor is caused to rotate with a power source for starting, and this rotation causes the generator of the first set to rotate and to generate electric power. The motor of the second set or later is caused to rotate with electric power generated by the electric generator of the previous set. The generator of the second set or later is caused to rotate with the rotation of the motor of its own set and to generate electric power.

### SUMMARY OF THE INVENTION

In a generator driven by a motor used for starting in the conventional technology, in the case of using a generator that is driven by an engine, the generator cannot be used as a generator for starting unless the engine is once started.

In general, a generator that is driven by an engine is started manually by a recoil starter.

Therefore, when a function of automatic starting is to be added to the generator which is driven by an engine, mechanical components such as ring gears have had to be added, and these are driven by a cell starter. Moreover, it is difficult for a user to add such a starting mechanism, and the user has needed to obtain a separate automatic starting generator.

The present invention is devised in view of the aforementioned points, and an object thereof is to provide a generator capable of using electric power from an external power supply device to start the generator itself.

In order to achieve the aforementioned object, a generator according to an aspect of the present invention includes: an engine; an alternator attached to an output shaft of the engine; an inverter that rectifies current flowing between the alternator and a power input-output part in both directions and performs power conversion; and an ECU that supplies electric power to the inverter and controls the engine and the inverter, wherein the generator includes a starting unit that supplies, to the ECU, electric power from an external power supply device to be connected to the power input-output part, and the alternator is energized to start the engine, by sending a starting initiation instruction from the ECU to the inverter.

In the aforementioned configuration, the starting unit includes a switch circuit which a user manipulates, and a power source switching circuit which is energized by the switch circuit and supplies the electric power to the ECU.

In the aforementioned configuration, the starting unit includes an automatic OFF circuit which turns off the switch circuit when the ECU detects starting of the engine.

According to an aspect of the present invention, the generator can be started by using electric power from an external power supply device. Moreover, when the starting unit is set to be able to be attached afterward, an existing generator can be made automatically started without using a recoil starter.

### BRIEF DESCRIPTION OF THE DRAWINGS

FIG. 1 is a perspective view showing an appearance of a generator according to a first embodiment;

FIG. 2 is a sectional view showing the generator of the first embodiment;

FIG. 3 is a circuit diagram showing circuits of the generator of the first embodiment;

FIG. 4 is a flowchart showing operation in the first embodiment;

FIG. 5 is a circuit diagram showing circuits of a generator of a second embodiment; and

FIG. 6 is a flowchart showing operation in the second embodiment.

### DETAILED DESCRIPTION OF THE PREFERRED EMBODIMENTS

Hereafter, embodiments of the present invention are described with reference to the drawings.

### First Embodiment

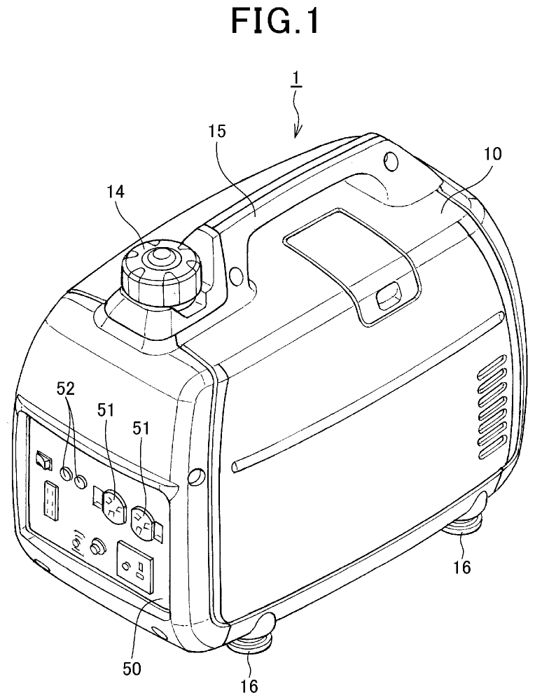

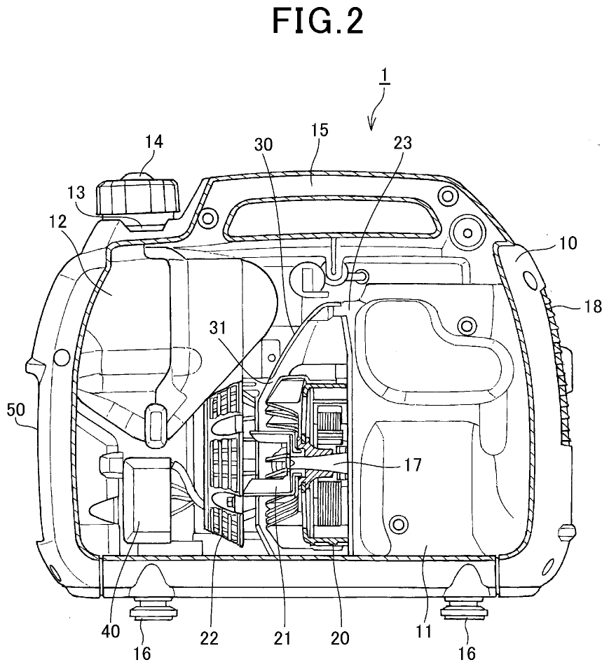

FIG. 1 is a perspective view showing an appearance of a generator according to a first embodiment of the present invention. FIG. 2 is a sectional view of the generator.

As shown in FIG. 1 and FIG. 2, in the present embodiment, a generator 1 includes a casing 10 which is formed of resin and shaped into a substantially rectangular solid. An engine 11 is housed on a rear side (right side in FIG. 2) inside the casing 10. Moreover, a fuel tank 12 is housed on a front side (left side in FIG. 2) inside the casing 10. An oil filler port 13 of the fuel tank 12 is provided on a top board of the casing 10 so as to protrude to the outside of the casing 10. An oil filler cap 14 for opening and closing the oil filler port 13 is detachably attached to the oil filler port 13.

Moreover, a grip 15 is provided on an upper surface of the casing 10, and a plurality of legs 16 supporting the casing 10 are attached to a bottom cover provided on a lower surface of the casing 10.

The engine 11 includes a cylinder, a combustion chamber and a crank chamber (which are not shown in the figures), a not-shown piston is reciprocally movably housed in the cylinder, and an output shaft 17 which is rotationally driven with this piston being driven is provided.

An alternator 20 is attached to the output shaft 17 protruding ahead of the engine 11 so as to be coaxial with the output shaft 17. Moreover, a fan 21 is coaxially attached ahead of the alternator 20 on the output shaft 17.

A recoil starter 22 for starting the engine 11 is arranged ahead of the fan 21.

Further, there is provided a configuration in which driving the engine 11 rotationally drives the alternator 20, which generates electric power, and rotationally drives the fan 21, which conducts intake of air outside the casing 10 and sends the air to the engine 11 side.

A shroud 23 which guides the sent air by the fan 21 to the periphery of the engine 11 is arranged inside the casing 10 and outside the engine 11.

A fan cover 30 covering the alternator 20 and the fan 21 is arranged at a front end of the shroud 23. The fan cover 30 is formed into a tapered shape such that its front side has a smaller diameter, and a ventilation opening 31 is formed in a front end part of the fan cover 30. The ventilation opening 31 is formed to be substantially concentric with the output shaft 17 of the engine 11.

The fan cover 30 is formed of a metal high in thermal conductivity or the like, and specifically, is formed of aluminum, aluminum alloy or the like, for example.

An inverter 40 is installed ahead of the fan 21.

A control panel 50 in which a power receptacle 51, a manipulation button 52 and the like are arranged is attached onto a lower front surface of the casing 10.

Moreover, an intake port (not shown) for taking external air into the inside of the casing 10 is formed in a side plate which is at a front surface of the casing 10 and at a portion lower than the control panel 50, and a discharge port 18 is formed on a rear surface of the casing 10.

Further, there is provided a configuration in which rotationally driving the fan 21 by driving the engine 11 causes air outside the casing 10 to be taken in from the intake port, and this air flows into the inside of the fan cover 30 through the ventilation opening 31, and after cooling the engine 11 during flowing between the engine 11 and the shroud 23, is discharged from the discharge port 18 to the outside.

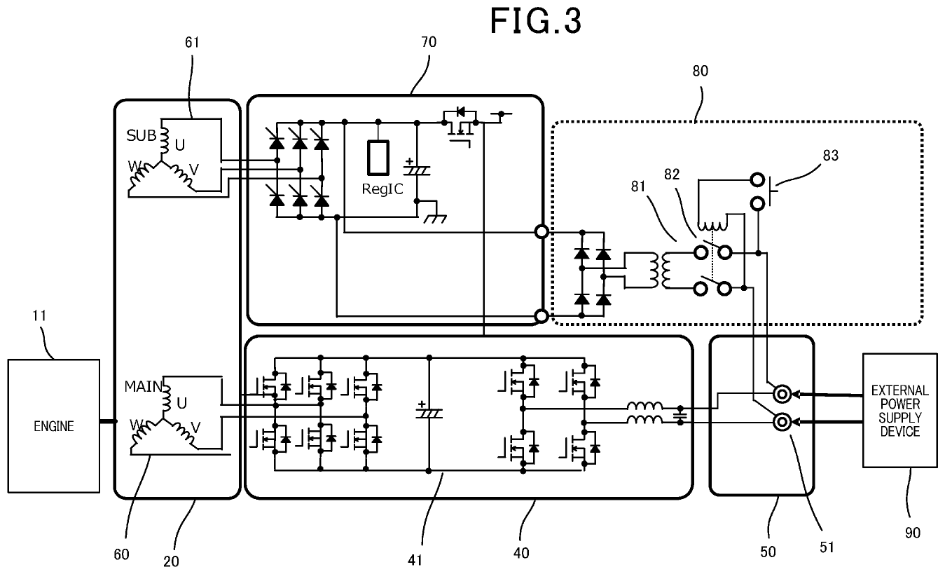

FIG. 3 is a circuit diagram showing electric circuits of the generator.

As shown in FIG. 3, the alternator 20 rotationally driven by the output shaft 17 rotated by the engine 11 being driven is connected to the engine 11. The alternator 20 includes a main stator coil 60 and a sub-stator coil 61.

The alternator 20 is configured to obtain electric power from the main stator coil 60 by a not-shown rotor being rotated by the rotation of the output shaft 17.

The inverter 40 performing current rectification and power conversion is connected to the main stator coil 60 of the alternator 20. The inverter 40 includes a rectification circuit 41 constituted of diodes and the like. In the present embodiment, the rectification circuit 41 can rectify current flowing in both directions.

The inverter 40 is connected to the power receptacle 51 of the control panel. Notably, the power receptacle 51 is a power input-output part of the present invention.

Namely, there is provided a configuration in which electric power is generated through the main stator coil 60 of the alternator 20 by the alternator 20 being rotationally driven through the output shaft 17 by the engine 11 being driven and is rectified by the inverter 40, so that the electric power can be supplied to the power receptacle 51 of the control panel.

Moreover, an ECU 70 (engine control unit) is connected to the sub-stator coil 61. The ECU 70 has a processor (not illustrated) and a memory (not illustrated) that stores programs and various data, and controls respective units of the generator 1 by executing, by the processor, the programs stored in the memory. The ECU 70 controls the engine 11, and supplies electric power to the inverter 40 and controls the same.

The generator 1 of the present embodiment includes a starting unit 80.

The starting unit 80 includes a power source switching circuit 81 connected to the power receptacle 51 of the control panel. The power source switching circuit 81 includes a relay circuit 82. The starting unit 80 includes a switch circuit 83 which energizes the relay circuit 82 with electric power which is to be supplied from the power receptacle 51 to the relay circuit 82.

The switch circuit 83 is configured to be turned on during a user's manipulation only.

There is provided a configuration in which when the switch circuit 83 is turned on, the power source switching circuit 81 is turned on by causing the relay circuit 82 to operate with the electric power from the power receptacle 51.

When the power source switching circuit 81 is turned on, electric power is supplied to the ECU 70 and electric power is supplied to the sub-stator coil 61.

Notably, the starting unit 80 is configured to be able to be attached afterward to an existing generator 1.

There is provided a configuration in which an external power supply device 90 such as a separate external generator or a battery is to be connected to the power receptacle 51.

Namely, in the present embodiment, there is provided a configuration to be able to start the generator 1 with the external power supply device 90.

Next, operation of the present embodiment is described with reference to a flowchart.

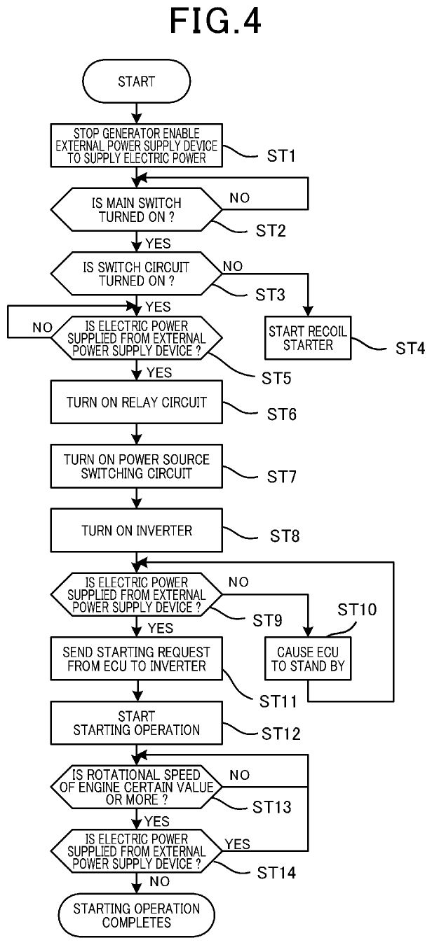

FIG. 4 is a flowchart showing operation of the first embodiment.

First, the external power supply device 90 is connected to the power receptacle 51 of the generator 1. The external power supply device 90 is, in the case of being the battery, electrically connected to the power receptacle 51, and in the case where the external power supply device 90 is the external generator, the generator is brought into the state where the generator is being driven to be able to supply electric power (ST1).

In this state, a main switch of the generator 1 is turned on (ST2) and the switch circuit 83 is turned on (ST3). When the switch circuit 83 is not turned on (ST3: NO), starting by the recoil starter is performed (ST4).

When electric power is supplied from the external power supply device 90 (ST5: YES), the relay circuit 82 is turned on (ST6) and the power source switching circuit 81 is turned on (ST7).

Thereby, the electric power from the external power supply device 90 is sent to the ECU 70 through the power source switching circuit 81, which turns on the ECU 70, and the ECU 70 being turned on causes the inverter 40 to be also turned on (ST8).

When electric power from the external power supply device 90 is supplied in this state (ST9: YES), the ECU 70 sends a starting instruction to the inverter 40 (ST11), and thereby, electric power is supplied from the inverter 40 to the main stator coil 60. When electric power from the external power supply device 90 is not supplied (ST9: NO), the ECU 70 stands by.

When the electric power is supplied to the main stator coil 60, a magnetic field arises at the main stator coil 60 and this magnetic field rotationally drives the rotor, which rotates the output shaft 17 of the engine 11. Thereby, the engine 11 is started (ST12).

After that, when the rotational speed of the engine 11 reaches a predetermined rotational speed (ST13: YES) and the switch circuit 83 is turned off, which cuts off the electric power from the external power supply device 90 (ST14: NO), the starting operation of the engine 11 is completed.

As described above, there are included in the present embodiment: the engine 11; the alternator 20 attached to the output shaft 17 of the engine 11; the inverter 40 which rectifies current flowing between the alternator 20 and the power receptacle 51 (power input-output part) in both directions; the ECU 70 which supplies electric power to the inverter 40 and controls the engine 11 and the inverter 40; and the starting unit 80 which supplies, to the ECU 70, electric power from the external power supply device 90 to be connected to the power receptacle 51, and the alternator 20 is energized to start the engine 11, by sending a starting initiation instruction from the ECU 70 to the inverter 40.

Thereby, the generator 1 can be started by using the electric power from the external power supply device 90. In this case, when an external generator is used as the external power supply device 90 and the generator used has a smaller displacement than the displacement of the generator 1 of the present embodiment, labor can be reduced when it is started manually using a recoil starter. Moreover, when the starting unit 80 is set to be able to be attached to an existing generator 1 afterward, it can be automatically started without using a recoil starter.

Moreover, in the present embodiment, the starting unit 80 includes the switch circuit 83 which is manipulated by a user, and the power source switching circuit 81 which is energized by the switch circuit 83 and supplies electric power to the ECU 70.

Thereby, electric power can be supplied to the ECU 70 by manipulating the switch circuit 83 to cause the power source switching circuit 81 to operate, and the engine 11 can be started through the inverter 40 and the alternator 20.

### Second Embodiment

Next, a second embodiment of the present invention is described.

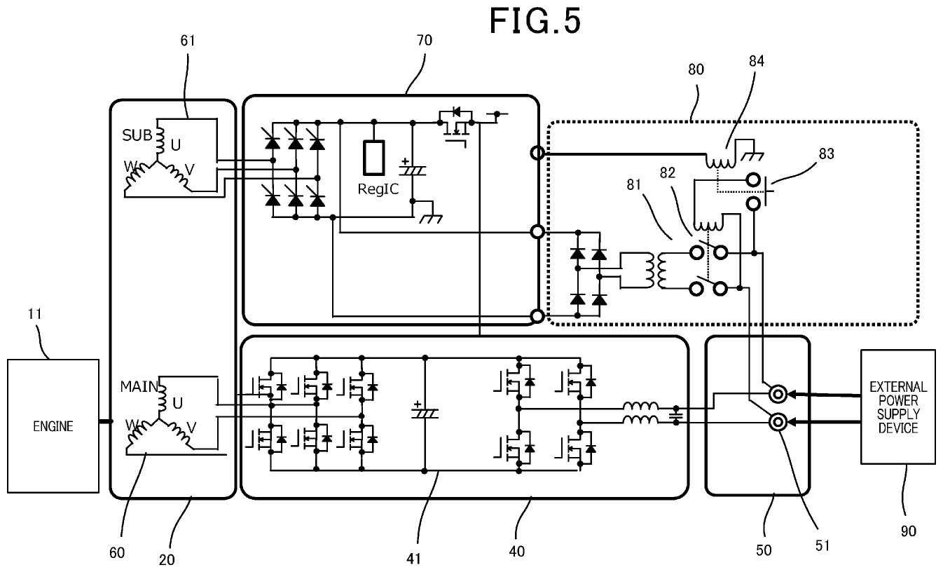

FIG. 5 is a circuit diagram showing the second embodiment of the present invention.

As shown in FIG. 5, in the present embodiment, the starting unit 80 includes an automatic OFF circuit 84 which turns off the switch circuit 83 when the ECU 70 detects starting of the engine 11.

Since the other components are similar to those in the first embodiment, the same portions are given the same signs and their description is omitted.

Next, operation of the present embodiment is described with reference to a flowchart.

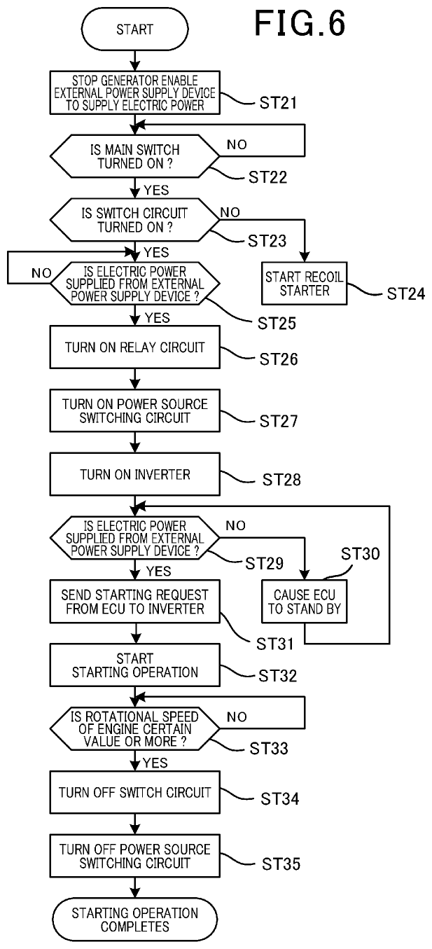

FIG. 6 is a flowchart showing operation of the second embodiment.

First, a power supply device is connected to the power receptacle 51 of the generator 1 (ST21).

In this state, a main switch of the generator 1 is turned on (ST22) and the switch circuit 83 is turned on (ST23). When the switch circuit 83 is not turned on (ST23: NO), starting by the recoil starter is performed (ST24).

When electric power is supplied from the power supply device (ST25: YES), the relay circuit 82 is turned on (ST26) and a power source switch is turned on (ST27).

Thereby, the electric power from the power supply device is sent to the ECU 70 through the power source switch, which turns on the ECU 70, and the ECU 70 being turned on causes the inverter 40 to be also turned on (ST28).

When electric power from the power supply device is supplied in this state (ST29: YES), the ECU 70 sends a starting instruction to the inverter 40 (ST31), and thereby, electric power is supplied from the inverter 40 to the main stator coil 60. When electric power from the external power supply device 90 is not supplied (ST29: NO), the ECU 70 stands by.

When the electric power is supplied to the main stator coil 60, a magnetic field arises at the main stator coil 60 and this magnetic field rotationally drives the rotor, which rotates the output shaft 17 of the engine 11. Thereby, the engine 11 is started (ST32).

After that, when the rotational speed of the engine 11 reaches a predetermined rotational speed (ST33: YES), the automatic OFF circuit 84 turns off the switch circuit 83 (ST34). Thereby, the power source switching circuit 81 is turned off (ST35) and the starting operation of the engine 11 is completed.

As described above, in the present embodiment, the starting unit 80 includes the automatic OFF circuit 84 which turns off the switch circuit 83 when the ECU 70 detects starting of the engine 11.

Thereby, when starting of the engine 11 completes, the switch circuit 83 can be automatically turned off to stop supplying electric power from the external power supply device 90.

While some embodiments of the present invention are described as above, various kinds of design changes may be implemented without departing from the spirit of the present invention.

### REFERENCE SIGNS LIST

1 Generator
10 Casing
11 Engine
17 Output shaft
20 Alternator
21 Fan
22 Recoil starter
23 Shroud
30 Fan cover
31 Ventilation opening
40 Inverter
41 Rectification circuit
50 Control panel
51 Power receptacle
52 Manipulation button
60 Main stator coil
61 Sub-stator coil
70 ECU
80 Starting unit
81 Power source switching circuit
82 Relay circuit
83 Switch circuit
84 Automatic OFF circuit
90 External power supply device

What is claimed is:

1. A generator comprising:
an engine;
an alternator attached to an output shaft of the engine;
an inverter that rectifies current flowing between the alternator and a power input-output part in both directions and performs power conversion; and
an ECU that supplies electric power to the inverter and controls the engine and the inverter,
wherein the generator comprises a starting unit that supplies, to the ECU, electric power from an external power supply device to be connected to the power input-output part, and
the alternator is energized to start the engine, by sending a starting initiation instruction from the ECU to the inverter.

2. The generator according to claim 1, wherein the starting unit includes a switch circuit which a user manipulates, and a power source switching circuit which is energized by the switch circuit and supplies the electric power to the ECU.

3. The generator according to claim 2, wherein the starting unit includes an automatic OFF circuit which turns off the switch circuit when the ECU detects starting of the engine.
